(19) United States
(12) Patent Application Publication
(10) Pub. No.: US 2012/0155647 A1
(43) Pub. Date: Jun. 21, 2012

(54) CRYPTOGRAPHIC DEVICES & METHODS

(75) Inventors: Jiang Zhang, La Jolla, CA (US); Alexander Medvinsky, San Diego, CA (US)

(73) Assignee: GENERAL INSTRUMENT CORPORATION, Horsham, PA (US)

(21) Appl. No.: 12/974,992

(22) Filed: Dec. 21, 2010

(51) Int. Cl. H04L 9/08

(52) U.S. Cl. 380/279; 380/44; 380/278

(57) ABSTRACT

A client device which utilizes a unit derivation key (UDK), a current unit key, a current unit key index (UKI) and a received UKI. The client device includes a processor to receive the received UKI, compare the received UKI with a current UKI, if the received UKI is not equivalent to the current UKI, utilize the UDK, the current unit key and the received UKI to derive a new unit key. A headend facility (HF) device which utilizes a current unit key and a current unit key index (UKI). A key infrastructure center (KIC) device which utilizes a derivation key.

### BACKGROUND

High speed communication networks are often used for services providing protected content, including digital data and/or media. With the prevalence of such services, conditional access technologies for preventing the unauthorized use and/or copying of protected content have become necessary. Encryption techniques are generally used for copyright protection purposes to prevent the unauthorized use of content. The content is encrypted at an upstream distribution facility, such as a headend facility (HF), using an encryption key and the encrypted content is distributed through the communications network. Client devices receive the encrypted content and decrypt it with a decryption key which may correspond with the encryption key used upstream to encrypt the content. This enables the receiving client devices to decrypt the encrypted content and to play or otherwise utilize the content through the client device.

In order for each device to securely obtain a content key, typically it has to be pre-provisioned with a unique cryptographic key called a unit key. The HF will typically contain a database of unit keys for all of the client devices associated with the HF and then make use of them to securely deliver a content key to each device. Unit keys utilized at an HF are generally held in secret. However, there is a possibility that an attacker will obtain access to, or otherwise compromise, the database of unit keys utilized at an HF. Once the unit keys at the HF have been compromised, the attacker may intercept messages intended for a legitimate device and forward them to unauthorized devices containing an illegal copy of one of the unit keys. Unauthorized devices thus configured will be capable of obtaining a clear content decryption key and thus will gain illegal access to protected digital content. To avoid this, the compromised unit keys at the HF must all be replaced with a new set of unique per device unit keys. However, replacing millions of client device unit keys can be difficult to accomplish due to both time and bandwidth overhead. And the distribution of new unit keys over a communications network may not be secure. And it may be inconvenient to install new unit keys offline, such as at a customer service center, where a new unit key may be directly installed into each client device.

### BRIEF SUMMARY OF THE INVENTION

According to different embodiments there are a client device, a headend facility (HF) device and/or a key infrastructure center (KIC) device. A unit key at the client device may be replaced in a manner that is both secure and convenient by utilizing a unit derivation key (UDK) which is previously stored in the client devices in a cryptographic system. After a security compromise occurs at the HF, the UDK at the client device enables the client device to derive a new unit key. By utilizing the UDK to derive the new decryption key, there is no need to compromise security by transmitting the new unit key over a communications network. Furthermore, the new unit key is derived conveniently at the client devices, without any need for transporting the client devices to a customer service center or other offline location where a new unit key would otherwise be installed directly into the client devices.

In a first embodiment, there is a client device which utilizes a unit derivation key (UDK), a current unit key, a current unit key index (UKI) and a received UKI. The client device comprising includes a processor to receive the received UKI and compare the received UKI with a current UKI. If the received UKI is not equivalent to the current UKI, it utilizes the UDK, the current unit key and the received UKI to derive a new unit key.

In a second embodiment, there is a method of utilizing a unit derivation key (UDK), a current unit key, a current unit key index (UKI) and a received UKI. The method includes receiving the received UKI, using a processor, and comparing the received UKI with a current UKI. If the received UKI is not equivalent to the current UKI, it utilizes the UDK, the current unit key and the received UKI to derive a new unit key.

In a third embodiment, there is a non-transitory computer readable medium storing computer readable instructions that when executed by a computer system perform a method of utilizing a unit derivation key (UDK), a current unit key, a current unit key index (UKI) and a received UKI. The method includes receiving the received UKI, using a processor, and comparing the received UKI with a current UKI. If the received UKI is not equivalent to the current UKI, it utilizes the UDK, the current unit key and the received UKI to derive a new unit key.

In a fourth embodiment, there is a headend facility (HF) device associated with a HF, which utilizes a current unit key, a current unit key index (UKI). The HF device includes a processor to, if the current unit key is compromised, apply a function to change the current UKI stored in the HF device to derive a new UKI in which a numerical difference differentiates the new UKI and the current UKI. It also transmits the new UKI.

In a fifth embodiment, there is a method of utilizing a current unit key and a current unit key index (UKI). The method includes, if the current unit key is compromised, applying a function, using a processor, to change the current UKI stored in the HF device to derive a new UKI in which a numerical difference differentiates the new UKI and the current UKI, and transmitting the new UKI.

In a sixth embodiment, there is a non-transitory computer readable medium storing computer readable instructions that when executed by a computer system perform a method of utilizing a current unit key and a current unit key index (UKI). The method includes, if the current unit key is compromised, applying a function, using a processor, to change the current UKI stored in the HF device to derive a new UKI in which a numerical difference differentiates the new UKI and the current UKI, and transmitting the new UKI.

In a seventh embodiment, there is a key infrastructure center (KIC) device associated with a KIC, which is operable to utilize a derivation key, a received unit key index (UKI), a current UKI, a client device unit identification and a current unit key. The KIC device includes a processor to receive the received unit key index (UKI), the client device unit identification and the current unit key and compare the received UKI with a current UKI. If the received UKI is not equivalent to the current UKI, it utilizes the derivation key, the client device unit identification, the current unit key, the current UKI and the received UKI to derive a new unit key.

In an eighth embodiment, there is a method of utilizing a derivation key. The method includes receiving a received unit key index (UKI), a client device unit identification and a current unit key. The method also includes comparing the received UKI with a current UKI, using a processor. If the received UKI is not equivalent to the current UKI, the method includes utilizing a client device unit identification, the current unit key, the current UKI and the received UKI and the derivation key to derive a new unit key.

In a ninth embodiment, there is a non-transitory computer readable medium storing computer readable instructions that when executed by a computer system perform a method of utilizing a derivation key. The method includes receiving a received unit key index (UKI), a client device unit identification and a current unit key. The method also includes comparing the received UKI with a current UKI, using a processor. If the received UKI is not equivalent to the current UKI, the method includes utilizing a client device unit identification, the current unit key, the current UKI and the received UKI and the derivation key to derive a new unit key.

### BRIEF DESCRIPTION OF DRAWINGS

Embodiments are described in detail in the following description with reference to the following figures. The embodiments are illustrated by way of example and are not limited in the accompanying figures in which like reference numerals indicate similar elements.

FIG. 1 is a system context diagram illustrating a cryptographic system 100, according to an embodiment;

FIG. 2 is a block diagram illustrating a client device 105 operable in the cryptographic system 100 shown in FIG. 1, according to an embodiment;

FIG. 3 is a block diagram illustrating a headend facility (HF) device 104 operable in the cryptographic system 100 shown in FIG. 1, according to an embodiment;

FIG. 4 is a block diagram illustrating a key infrastructure center (KIC) device 102 operable in the cryptographic system 100 shown in FIG. 1, according to an embodiment;

FIG. 5 is a flow diagram illustrating a method 500 of using a unit derivation key (UDK) and a unit key index (UKI) in the client device 105 shown in FIG. 2, according to an embodiment;

FIG. 6 is a flow diagram illustrating a method 600 of using a unit key index (UKI) in the HF device 104 shown in FIG. 3, according to an embodiment;

FIG. 7 is a flow diagram illustrating a method 700 of using a UDK and a UKI in the KIC device 102 shown in FIG. 4, according to an embodiment; and

FIG. 8 block diagram illustrating a computer system 800 to provide a hardware platform for the client device 105, the HF device 104 and/or the KIC device 102, according to different embodiments.

### DETAILED DESCRIPTION OF EMBODIMENTS

For simplicity and illustrative purposes, the principles of the embodiments are described by referring mainly to examples thereof. In the following description, numerous specific details are set forth in order to provide a thorough understanding of the embodiments. It is apparent however, to one of ordinary skill in the art, that the embodiments may be practiced without limitation to these specific details. In some instances, well known methods and structures have not been described in detail so as not to unnecessarily obscure the embodiments. Furthermore, different embodiments are described below. The embodiments may be used or performed together in different combinations.

### 1. DEFINITIONS

The term key infrastructure center (KIC), as used herein, is a facility or arrangement of resources in engaged in deriving (i.e., making), managing, distributing, using, storing and revoking keys. It binds keys with users by means of a certificate authority. A KIC may also be referred to as a public key infrastructure (PKI).

The term headend facility (HF), as used herein, is a facility for receiving signals, such as video and/or television signals for processing and distribution over a content distribution system, such as cable television system. The HF may be unstaffed and is typically a building or housing for electronic equipment used to receive and re-transmit video and other content over a content distribution infrastructure. HFs are often located in communications substations and in Internet communications networks.

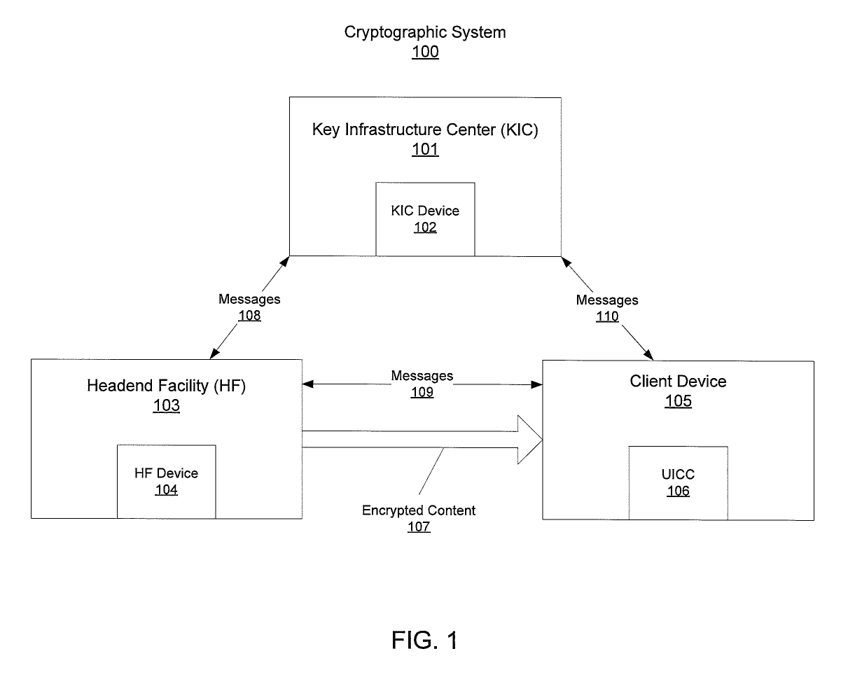

The term cryptographic system, as used herein, is a system including at least one KIC, at least one HF associated with the KIC, and one or more client devices associated with the HF. A cryptographic system 100 is illustrated in FIG. 1.

The term universal integrated circuit card (UICC), as used herein, is a storage configuration in a client device assuring integrity and security of a unit identification (UID) associated with the client device, such as a serial number. A UICC receives, stores and transmits key information associated with the client device which may associated with the client device through cryptographic systems which are associated with the client device.

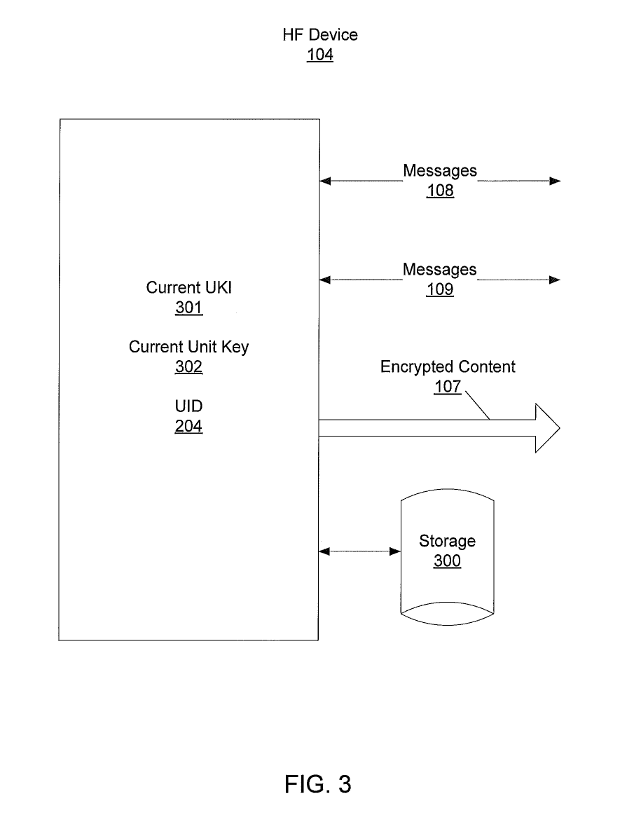

The term HF device, as used herein, is a device associated with a HF. The HF device may, at least, receive, manage, distribute, use, and/or store keys and/or key information associated with the HF through cryptographic systems which are associated with the HF. An HF device 104 is illustrated in FIG. 3.

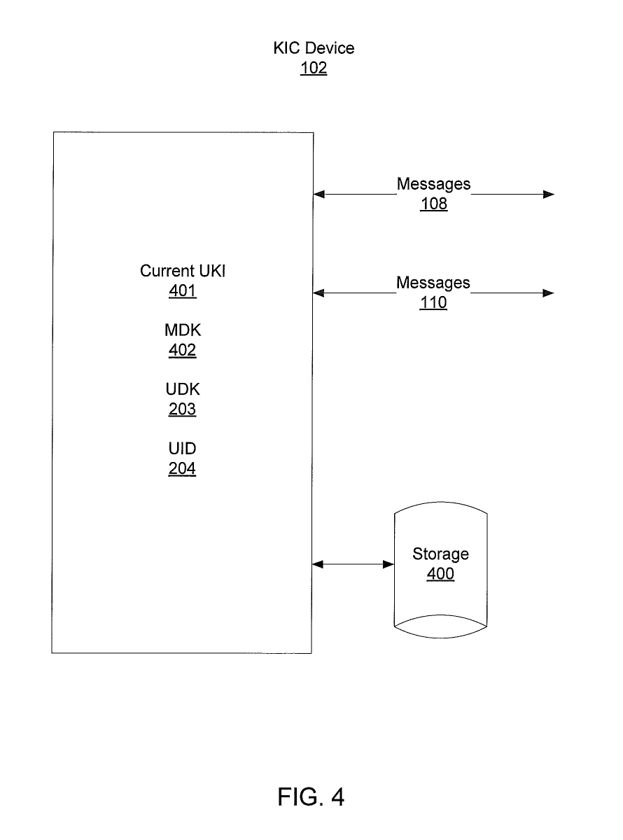

The term KIC device, as used herein, is a device associated with a KIC. The KIC device may, at least, derive, receive, manage, distribute, use, and/or store keys and/or key information associated with the KIC through cryptographic systems which are associated with the KIC. A KIC device 102 is illustrated in FIG. 4.

The term content key, as used herein, is an encryption key for encrypting/decrypting digital content. A content key may also be referred to as a traffic key.

The term service key, as used herein, is an encryption key for encrypting/decrypting content keys. A service key may also be referred to as an entitlement key.

The term unit key, as used herein, is an encryption key for encrypting/decrypting service keys. UK is an acronym associated herein and used interchangeably with the term unit key. An index associated with the unit key is referred to as a unit key index (UKI).

The term unit derivation key (UDK), as used herein, is an encryption key used in deriving a unit key. An index associated with the UDK is referred to as a unit derivation key index (UDKI). A UDK may also be referred to as a unit-unit key derivation key (UUKDK) and an acronym for a UUKDK index is UUKDKI.

The term master derivation key (MDK), as used herein, is an encryption key used in deriving a UDK. An index associated with the MDK is referred to as a master derivation key index (MDKI). A MDK may also be referred to as a master-unit key derivation key (MUKDK) and an acronym for a MUKDK index is MUKDKI.

### 2. ARCHITECTURE

FIG. 1 is a system context diagram showing a simple cryptographic system 100. A client device 105 is disclosed in the cryptographic system 100 associated with an HF 103 and a KIC 101. Encrypted content arrives at the client device 105 where it is decrypted using a content key. A content key may be encrypted/decrypted using another key called a service key. Content keys and service keys are distributed to the client device 105 via messages 109 which may be sent with encrypted content 107 from the HF device 104 associated with the HF 103. A unit key may be used to encrypt/decrypt a service key distributed to the client device 105 to decrypt content keys. However, for security purposes, a unit key is not exchanged between the client device 105 and the HF 103. The client device 105 commonly has a unit key directly installed in it after it is manufactured or registered with the HF 103. If the unit key in the client device 105 is somehow compromised, it may need to be replaced. A less desirable mode of replacing the unit key is to take it to service center which may be associated with the HF device 103. This is very inconvenient and may lead to loss of service. An alternative way to replace the unit key in the client device 105 is by deriving (i.e., making) a new unit key within the client device 105 itself. The unit derivation key (UDK) serves this function. A UDK may also installed in the client device 105 in the manufacturing and/or in the registration process. However, the UDK may be used repeatedly to replace unit keys in the client device 105.

As noted above, the UDK is an encryption key used to derive other keys. The UDK may be an algorithm which may be executed one or multiple times in deriving a unit key. The purpose of the UDK is to provide client devices, such as client device 105, an independent and secure way to produce new unit keys if these are needed by the client device. For instance, a unit key used for encryption purposes at a HF may become compromised by a security breach, a cyber attack, a hacker discovering a workaround or the like, and therefore, the unit key is replaced. However, the corresponding unit key at the client device used for decryption purposes must also be replaced. By utilizing the UDK stored at the client device, the new unit key for decryption purposes does not need to be communicated over a communications network and the client device does not need to be transported to a service center for direct installation of the new unit key in the client device.

The client device 105 may be a set top box, a television or some other consumer electronic device. A client device generally has a universal integrated circuit card (UICC), such as UICC 106 for storing a unit identification (UID). The UICC 106 may store a unit key and the UDK for decryption purposes, and for storing other security measures and private information. A UICC may also include a CPU, ROM, RAM, EEPROM and I/O circuits.

The client device 105 is associated with an HF device 104 in the HF 103 and the KIC device 102 of the KIC 101 in the cryptographic system 100. The HF 103 may be facility for receiving television and content signals for processing and distribution over a communications platform. It provides centralized functions such as demodulation of signals and data conversion into packetized information streams. It is often a source for distributing secured content. The HF device 104 may be a server, a computer or any other modular component having a processor and a storage. Different hardware configurations are described in more detail below. The HF device 104 may operate independently from the HF 103, but it is associated with it in the cryptographic system 100.

The KIC 101 may be an independent organization which generates keys and certificates and distributes them to other organizations and HFs. The KIC 101 generally one or more servers as the KIC device 102, for generating and distributing the keys. The KIC 101, as a whole, involves a set of hardware, software, people, policies, and procedures to create, manage, distribute, use, store, and revoke keys. A KIC device 102 may be a server, a computer or any other modular component having a processor and a storage. The KIC device 102, may operate independently from the KIC 101, but it is associated with it in the cryptographic system 100.

In cryptography, a KIC, such as KIC 101, includes an arrangement that binds keys with respective user identities by means of a certificate. A user identity must be unique within each certificate authority domain, such as the cryptographic system 100. The unique identity is usually associated with individual client devices through the unit identifier (UID). The UID is usually stored in the UICC of the client device, and is often also stored at the HF and KIC. The UID is often a unique serial number, generally an alphanumeric, associated with a client device, such as client device 105. The UICC 106 may also be used to store keys the client device 105 utilizes to interact with the HF 103 and the KIC 101 in the cryptographic system 100.

Unit keys may be stored in the client device 105, often in the UICC 106, and in the HF device 104 of the HF 103. Unit keys may also be stored in the KIC device 102 of the KIC 101. The unit key at the HF 103 is used to encrypt service keys at HF 103. Service keys may be used in encrypting/decrypting content keys, which may be used in encrypting/decrypting content.

The unit key at a client device 105 is used by the client device to decrypt the encrypted service keys received from the HF 103. The unit key may be randomly generated or specifically derived for the client device 105. The unit key may be derived at the client device 105. For security reasons, it is not desirable to deliver a unit key to a client device, such as via a message 109. It is more secure deliver an initial unit key to a client device in a secure registration process or to have it installed, such as in the UICC or other storage, of the client device at the factory when it is manufactured.

A unit key index (UKI) is an index, associated with a unit key and may be set by an administrator at the HF 103. The UKI is generally stored at a client device in the UICC and it is also stored at the HF. Commonly, the UKI for a unit key is the same at all the client devices associated with a HF. When a new unit key needs to be derived due to a compromise in the unit at the HF, the UKI is changed (e.g., incremented, decremented, pseudo-randomly altered as by a random number generating function, etc.) at the HF whenever a new unit key is derived there. When the HF communicates with the client devices, such as by messages 109, the UKI is included in the message 109 received at the client device 105. The received UKI is compared with the current UKI which may be stored in the UICC 106 of the client device 105. If the current UKI stored in the client device 105 is different than the received UKI in the message 109, a new unit key is derived at the client device 105 using a UDK. After it is derived, the new unit key is stored in the UICC 106 with the new UKI received in the message 109.

Generally, only the client device 105 stores the UDK. It may also be stored at the KIC 101 or at the HF 103. However, for security purposes, a UDK is generally not stored at the HF 103. Because a UDK is not communicated over the communications network, this enhances its secured status. In one embodiment, no UDK is stored at the HF 103 and if the unit key at the client device 105 is compromised, the client device 105 is simply removed from the cryptographic system, or has a new UDK directly installed through a customer service center. In other embodiment, a UDK may be stored in HF 103 or the KIC 101. The client device 105 uses the UDK to derive a new unit key when the unit key at the HF is compromised.

The KIC 101 may also utilize a UDK to derive a new unit key at the KIC device 102. The KIC 101 may accomplish this by storing a copy of all the UDKs for all the client devices, such as client device 105 in the cryptographic system 100. In an alternative embodiment, the KIC 101 may instead store a master derivation key (MDK) which may be used to derive either one UDK or all the UDKs for all the client devices in the cryptographic system 100. A UDK is commonly unique for each client device. The MDK may utilize the UID and other mathematical parameters in deriving the UDKs to generate a new unit key. The MDK may be used rather than keeping a record at the KIC 101 of all the individual UDKs for all the client devices in the cryptographic system 100. The use of the MDK at the KIC 101 is preferable to storing all the unique UDKs stored there, for storage and security purposes.

### 2. Systems

As noted above, FIG. 1 illustrates a cryptographic system 100, according to an embodiment. The cryptographic system 100 may include a KIC 101, including a KIC device 102, and an HF 103, including an HF device 104, and a client device 105 including a UICC 106. Keys and/or encrypted content 107 may be distributed from the HF 103 to the client device 105. Messages 109 between the HF 103 and the client device 105 can be ECMs and/or EMMs which may include a UID, a UKI, content keys and service keys. Messages 108 between the KIC 101 and the HF 103 are messages which may include a UID and a UKI. Messages 110 between the KIC 101 and the client device 105 are messages which may include a UID and a UKI.

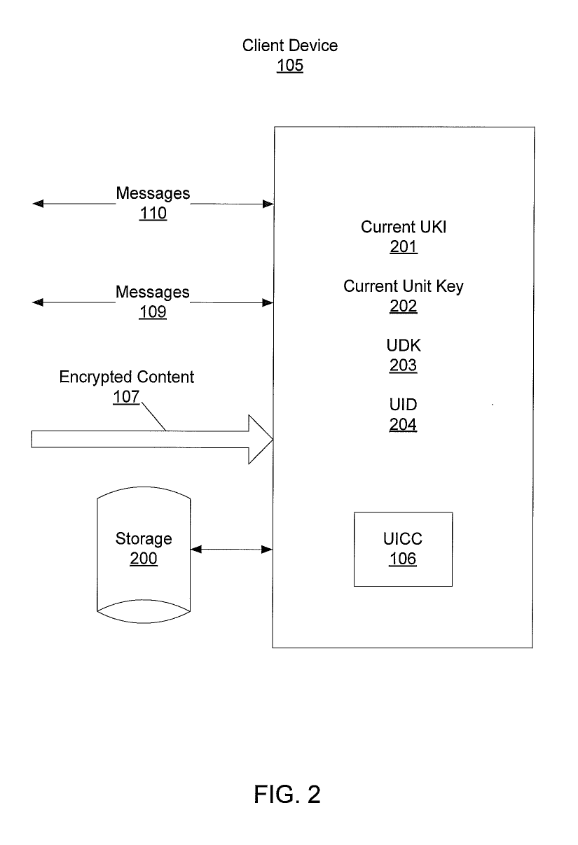

FIG. 2 illustrates the client device 105 including the UICC 106, according to an embodiment. The client device 105 may include a storage 200, storing a current UKI 201, a current UK 202, a UDK 203 and a UID 204. The client device 105 receives encrypted content 107 and communicates via messages 109 and 110, as described above with respect to the cryptographic system 100.

FIG. 3 illustrates the HF device 104, according to an embodiment. The HF device 104 may include a storage 300, storing a current UKI 301, a current unit key 302 and the UID 204. The current UKI 301 may the same or different from the current UKI 201 as stored on the client device 105 as described above. The HF device 104 distributes encrypted content 107 and communicates via messages 108 and 109, as described above with respect to the cryptographic system 100.

FIG. 4 illustrates the KIC device 102, according to an embodiment. The KIC device 102 may include a storage 400, and may store a current UKI 401, a MDK 402 and the UID 204 for an individual device. The current UKI 401 may the same or different from the current UK's 201 and 301 stored on, respectively, the client device 105 and the HF device 104 as described above. The KIC device communicates via messages 108 and 109, as described above with respect to the cryptographic system 100.

### 3. EXAMPLES

### Example 1

An example is described with respect to operating the cryptographic system 100 when the HF 103 is compromised.

One or more unit keys at HF 103 are determined to be compromised. After these unit keys are determined to be compromised at the HF 103, the HF 103 may communicate a request to the KIC 101 to recover all the unit keys. The process of recovering is described with respect to the entities in the cryptographic system 100.

The first entity in the cryptographic system 100 is the KIC 101. As an independent organization, it may generate keys and certificates for client devices such as client device 105. It also stores an MDK, and a unit key for each client device. The KIC may also derive a UDK for each client device. The KIC 101 may also provide a unit key to the HF 103 where it is stored.

The KIC 101 also utilizes the MDK. When one or more UDKs are compromised at HF 103, the KIC 101 assists the HF 103 to generate a new UDK for each compromised client device using the MDK. In using the MDK to derive the UDK a 128-bit advanced encryption system (AES) key may be used as the symmetric key, but the algorithm might instead use other symmetric key algorithms. The MDK 402 should not be communicated out of the KIC 101 in order to preserve its secured status.

The second entity in the cryptographic system 100 is the HF 103. The HF 103 stores a current unit key for each client device, such as client device 105, as well as the current UKI. The UKI is commonly the same for all the client devices. When a unit key is compromised at the HF 103, the HF 103 may communicate a command in a message 109 to all the client devices to increment their current UKI, such as current UKI 103 and replace it with a new UKI. The command may also include instructions for the client devices to derive a new unit key. At the same time, the HF 103 also may provide a current unit key list to the KIC 101 for generating a new unit key list with new UK's at the KIC 101. The original unit key provisioned in the HF 103 may be received from the KIC 101 or exchanged with the client device, such as client device 105, using a public key algorithm. If the unit key is exchanged with the client device 105, the HF 103 may provide the unit key to the KIC 101 for generating a new unit key.

The third entity in the cryptographic system 100 is the client device 105. In its UICC 106, the client device 105 may store the UDK 203 and the current unit key 202. In UICC 106, the client device 105 may derive a new unit key using the UDK 203. The original unit key provisioned in the client device 105 may be provided by the KIC 101 or exchanged with the HF 103 using a public key algorithm.

### Example 2

An example is described with respect to initially provisioning the cryptographic system 100.

The UDK is first derived and generated for each client device 105, for instance, by generating a 128-bit random number constant as a secret constant also stored in a secure token in the KIC 101. For each UICC, hashing function SHA256 may be used to hash the concatenation of UID 204 and the constant using the MDK to encrypt the 32-byte hash value with an AES mode setting the IV as all-zero. Then, using the last block of cipher text as the 16-byte UDK, (i.e. UDK=LSB₁₆(E{MUKDK}(SHA256(UID∥Constant))), where E{K}(M) represents encrypting message M with key K and LSBn(S) represents the least significant n bits of binary string S. The key derivation algorithm does not have to be AES. Any other key derivation algorithm may be used.

For each UICC, the KIC 101 generates a 16-byte random number as the unit key 202. The KIC 101 sets the UKI 201 for the unit key 202. Normally the UKI 201 starts with 0 if not otherwise specified. In some cases, the HF 103 may specify the UKI 201. The KIC 101 delivers the unit key list including UlDs, UK's and the unit keys to HF 103 which stores these into the storage 300. If the KIC 101 and HF 103 are using a public key algorithm to exchange the unit keys, the unit key list is sent to the HF 103.

The KIC 101 may deliver the UID 204, UKI 201, unit key 202, and UDK 203 to a factory to load into the UICC 106 of client device 105. If the KIC 101 is using a public key algorithm to exchange the unit key 202, the unit key 202 or the private key with the certificate is sent to the UICC 106 in client device 105.

The HF 103 may store the UID 204 and current unit key 302 into storage 300. As the UKI 301 may be same for all the client devices, UKI 301 may be saved into a system status file.

After receiving the UID 204, UKI 201, unit key 202, and UDK 203, the UICC 106 on the client device 105 saves UID 204 into permanent storage and stores UKI 201, unit key 202, and UDK 203 persistently. How the different key data is stored at the client device 105, the HF 103 and the KIC 101 can be summarized as shown in Table 1 below.

TABLE 1

| | Length | Client | | |
|---|---|---|---|---|
| Data Name | (Bytes) | Device 105 | HF 103 | KIC 101 |
| MDK 402 | 16 | No | No | Yes |
| Constant | 16 | No | No | Yes |
| UDK 203 | 16 | Yes | No | Yes or No |
| UKI 201, 301, 401 | 1 | Yes | Yes | No |
| UID 204 | 6 | Yes | Yes | No |
| unit key 202, 302 | 16 | Yes | Yes | No |

### Example 3

Another example is described with respect to operating the cryptographic system 100 when the HF 103 is compromised.

If the unit key 302 is compromised at the HF 103, the HF 103 increments the current UKI 301 and broadcasts it to all the client devices, such as client device 105. The UICC 106 on the client device 105 may require the newest UKI in order to obtain access to the encrypted content, such as if the UKI is used in the key derivation to decrypt the EMM and then the ECM to get a content key. Once the UKI 301 is incremented at HF 103, the UICC 106 at client device 105 receives the new UKI and consequently switches to a new unit key.

The HF 103 may provide the new UKI and the prior unit key list to the KIC 101 to generate a new unit key list. The UID and the prior unit key list may include the current UKI 301, UlDs such as UID 204 and unit keys such as current unit key 301. The HF 103 replaces the current unit keys in the storage 300 with the new unit keys provided from the KIC 101. The HF 103 may use the new unit key to deliver the messages 110 to the client device 105.

When the KIC 101 gets the current unit key list and UK's from the HF 103, the KIC 101 verifies the new UKI is greater than the current UKI 401, then retrieves the MDK and the constant to derive the UDK for each client device, such as client device 105. For example, for each UID such as UID 204, the hashing function SHA256 hashes the concatenation of the UID and the constant and uses MDK 402 to encrypt the 32-byte hash value. The last block of the cipher text is the derived UDK 203 for the UID 204. Then the KIC 101 uses the UDK 203 to derive the new unit key. Once all the unit keys are replaced, the KIC 101 returns the new unit key list to HF 103 with the new UKI.

When the client device 105 detects the UKI in the received message 109 is different (e.g., greater, lesser, randomly changed) than the current UKI 201 saved in the storage 200, the client device 105 retrieves the UDK 203 to derive the new unit key. For example, the client device 105 uses the UDK 203 may encrypt the current unit key 202 according to a function and use the result to replace the current unit key 202. Also the new UKI is stored in storage 200 replacing the current UKI 201.

After these processes are completed, the current unit key 202, 302 have been changed to the new unit key. An attacker obtaining the prior unit key list should not be able to obtain the new unit key values, because the attacker doesn't have access to the UDK 203. Even if the attacker were to compromise a single client device to get one UDK, this compromise to one client device does not affect other client devices in the cryptographic system 100, since each client device has a unique UDK.

### Example 4

In this example a scheme for an MDK recovery from an MDK compromise at a KIC is demonstrated. The KIC stores information which may be used derive a UDK, such as the MDK and a constant. This limit on what is stored at the KIC is so that if the KIC is compromised, the attacker won't be able to obtain the all the unit keys or query the associated client devices to change the unit key based on the compromise at the KIC. To recover from this MDK compromise, KIC may proceed as follows:

The KIC device in the KIC stores the compromised UDK derivation information and generates a new set of UDK derivation information. The KIC may store the compromised MDK and the constant and randomly generate a new MDK and new constant, denoted as MDK-1 and Cnst-1.

The KIC obtains a unit key list and a current UDK Index from a HF and derives a new UDK for each client device. For example, for each UID, the KIC device uses the MDK-1 and Cnst-1 to generate the new UDK, denoted as UDK-1. For instance UDK-1=LSB₁₆(E{MDK1}(SHA256(UID∥Cnst1))), incrementing the old UDKI by 1 as a new UDKI, UDKI-1.

For each UID, the KIC also derives its old UDK to encrypt and authenticate a new UDK, UDK-1. For instance, by using the old MDK and constant, Cnst, to derive the old UDK and using the old UDK to encrypt the UDK-1 and generate the AES-CMAC over the UID, UDKI-1 and the encrypted UDK-1. For instance, E{UDK}(UDK1)∥AES-CMAC(UDK, UID∥UDKI∥UDKI1∥E{UDK}(UDK1)). This is to prevent the HF, which manages the associated unit keys but not UDKs, from changing the UDK or allowing the UDK-1 to be compromised at the HF.

The KIC uses the current unit key to encrypt the data generated in previous step. For example, use AES CBC mode with all-zero IV to encrypt also generates the AES-CMAC over the UID, UDKI1 and the unit key encrypted data, i.e. E{UK}(E{UDK}(UDK1)∥AES-CMAC(UDK, UID∥UDKI∥UDKI1∥E{UDK}(UDK1)))∥AES-CMAC(UK, UID∥UDKI∥UDKI1∥E{UK}(E{UDK}(UDK1)∥AES-CMAC(UDK, UID∥UDKI∥UDKI1∥E{UDK}(UDK1))))). In this circumstance, the KIC attacker would have knowledge of the old UDK, so the data encrypted with old UDK is not secure. So the unit key, which is not known by the attacker, is used to protect the UDK update information.

Once a new UDK is generated, authenticated and encrypted for each client device, the KIC transmits this information to the HF to distribute to the associated client devices to update their respective UDK.

The cryptographic system with the HF, the KIC and the associated client devices does not have to change UDK immediately, but it is safer to update UDK without delay because once the attackers compromise the unit keys from HF, they may also change both the UDK and unit key, such that the KIC and the HF may lose cryptographic security of the associated client devices.

When the HF updates the UDK, it provides the KIC a list of unit keys. The KIC generates a new UDK for each device and the HF may send the encrypted and authenticated data to the device. For example, the data may include the UID, UDK and UKDKI-1, i.e. UID∥UDKI∥UDKI1∥E{UK}(E{UDK}(UDK1)∥AES-CMAC(UDK, UID∥UDKI∥UDKI1∥E{UDK}(UDK1)))∥AES-CMAC(UK, UID∥UDKI∥UDKI1∥E{UK}(E{UDK}(UDK1)∥AES-CMAC(UDK, UID∥UDKI∥UDKI1∥E{UDK}(UDK1))))).

Once a client device receives this message, it authenticates the message using a UID check. It may then verify that the old UDKI matches the current one saved persistently. It may then verify that the new UDKI, UDKI-1 is different than the current UDKI. It may then retrieve the unit key and verify an authentication signature signed with the unit key is correct. It may use the unit key to decrypt the unit key encrypted data to get the UDK protected data, e.g. in the above example, the data could be E{UDK}(UDK1)∥AES-CMAC(UDK, UID∥UDKI∥UDKI1∥E{UDK}(UDK1)). The client device may then retrieve the current UDK and verify the signature signed by UDK in the decrypted message is correct and use the UDK to decrypt the UDK-1. The client device may use the UDKI-1 to replace the stored UDKI and use the UDK-1 to replace the stored UDK.

After the UDK has been updated optionally, the HF may change the unit key at the same time as described above in examples 1-3.

### Example 5

If a client device is compromised, this won't affect associated other client devices, the HF device or the KIC device in a cryptographic system, since the UKI, UDKI and UID are not held secret. Only the UDK and unit key are used by a client device so there is no need to recover these keys. The solution is that the HF can simply remove the compromised client device from the cryptographic system.

### 4. METHODS

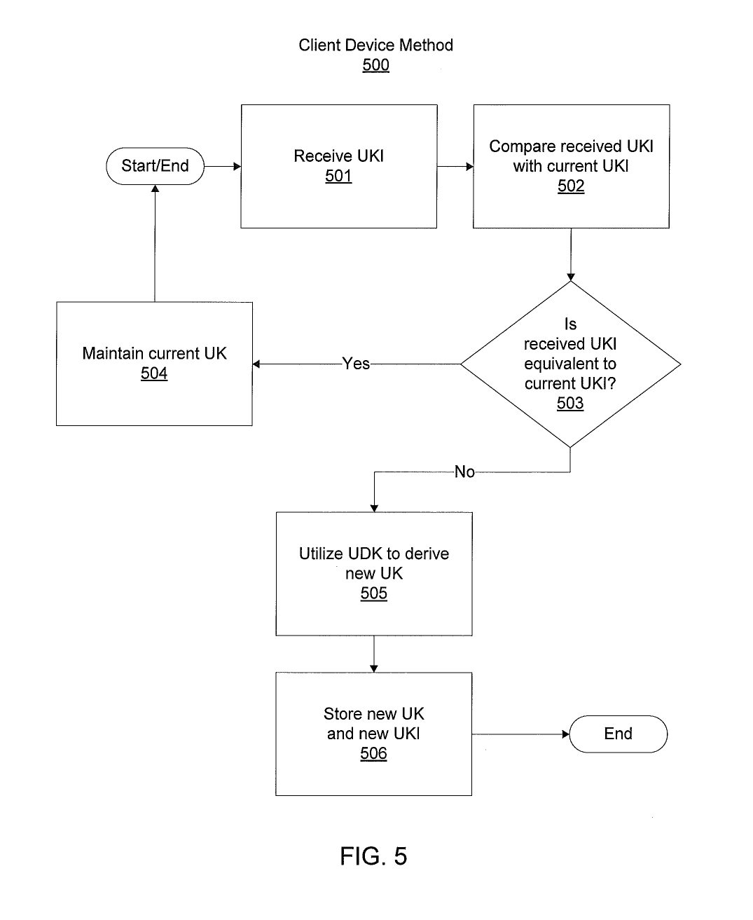

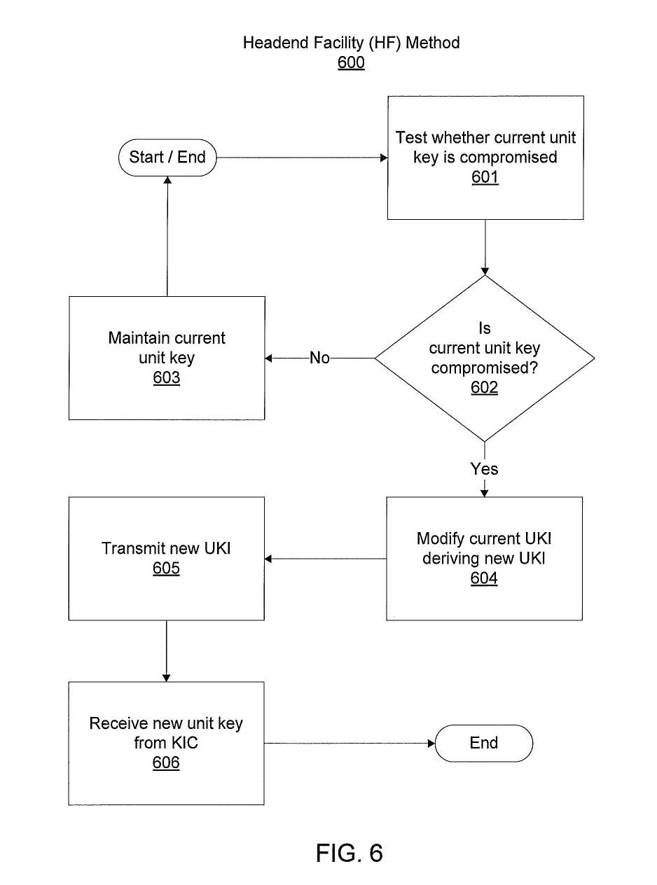

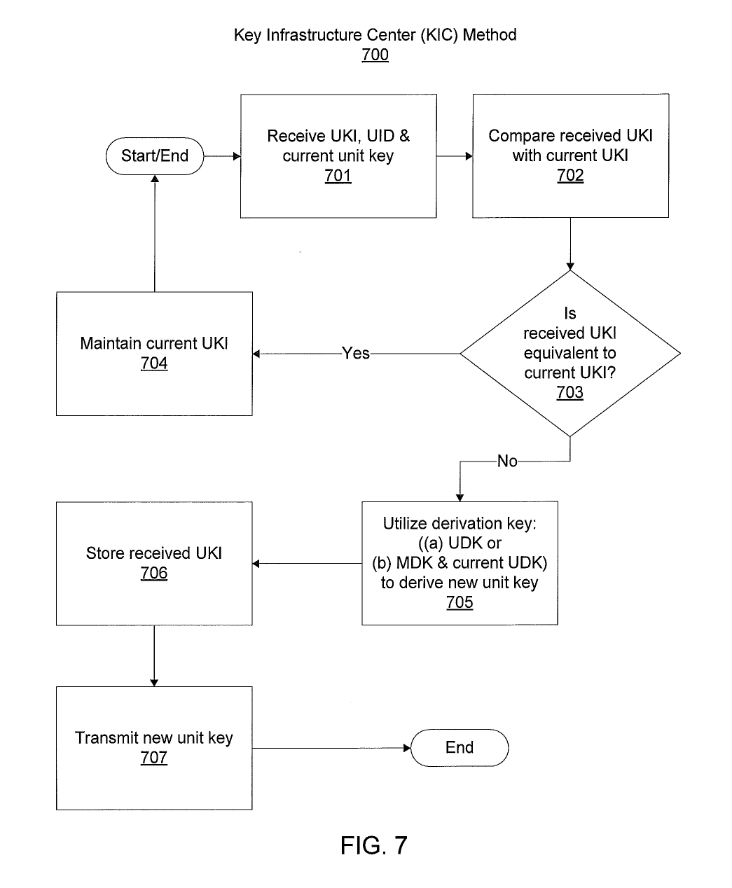

FIGS. 5, 6 and 7 illustrate, respectively, methods 500, 600 and 700, according to embodiments, for using a UKI and/or a UDK or an MDK. The methods herein are described with respect to the cryptographic system 100 shown in FIG. 1 by way of example and not limitation. These methods may be performed in other systems. The steps of the methods may be performed in a different sequence or one or more may be omitted.

Method 500 illustrates a client device method of using a UDK, a current unit key, and a UKI at a client device 105 operable in the cryptographic system 100. At step 501, the client device 105 receives a UKI, for example, via a message 109 from the HF 103.

At step 502, the client device 105 compares the received UKI with the current UKI 201 stored in the storage 200.

At step 503, the client device 105 determines whether the received UKI is different than the current UKI 201. If the current UKI 201 and the received UKI are the same, the client device 105 proceeds to step 504 and maintains the current UK 202 stored in the storage 200. However, if the received UKI is not equivalent to the current UKI, the client device 105 proceeds to step 505.

At step 505, the client device 105 utilizes the UDK 203, the current unit key and the received UKI to derive a new unit key. The new unit key may be derived by encrypting the current unit key one or more number N of times associated with a numerical, N being the difference, and defines the number of times the function/encryption is run using, for example, ESD, HASHMAC, CMAC, one way function. Other key derivation functions may be used in generating the N difference between the new UKI and the current UKI.

At step 506, the client device 105 stores the new unit key in storage 200, optionally with the current unit key. The received UKI may also be stored and associated with the new unit key.

Method 600 illustrates a headend facility method of using a UKI in an HF device 104 operable in the cryptographic system 100. At step 601, the HF device tests or otherwise determines whether the current unit key 302 stored in storage 300 is compromised.

At step 602, the HF device 104 makes a determination whether the current unit key 302 is compromised. If the current unit key 302 is not compromised, the HF device 104 proceeds to step 603 and maintains the current unit key 302 stored in the storage 300. However, if the current unit key 302 is compromised, the HF device 104 proceeds to step 604.

At step 604, the HF device 104 modifies (e.g., increments, decrements, randomly changes) the current UKI 301 stored in the storage 300 forming a new UKI which the HF device 104 stores in the storage 300.

At step 605, the HF device 104 transmits the new UKI using a message 108 or 109 to either the client device 105 or the KIC 101. The HF device may also transmit the current UKI, the current unit key and a client device identification to the KIC 101.

At step 606, the HF device receives a new unit key from the KIC 101. The HF device 104 recovers the new unit key, such as via message 108 and stores the new unit key in storage 300.

Method 700 illustrates a key infrastructure center method of using at least one of a UDK or an MDK with a UDK in a device such as the KIC device 102 operable in the cryptographic system 100. At step 701, the KIC device 102 receives a UKI via messages 108 and/or 110. The KIC device 102 may also receive the current UKI, the current unit key and a client device identification.

At step 702, the KIC device 102 compares the received UKI with the current UKI 401.

At step 703, the KIC device 102 determines whether the received UKI is different than the current UKI 401. If the current UKI 401 and the received UKI are equivalent, the KIC device 102 proceeds to step 704 and maintains the current UKI 401. However, if the received UKI is not equivalent to the current UKI 401, the KIC device 102 proceeds to step 705.

At step 705, the KIC device 101 utilizes a UID such as UID 204, the current unit key, the current UKI 401, the received UKI and at least one of the UDK 203 and the MDK 402 stored in the storage 400 to derive a new unit key. The MDK 402 may first be utilized in deriving a UDK with the UID such as UID 204. The UDK is operable to derive the new unit key by encrypting the current unit key one or more number of times associated with the difference between the new UKI and the current UKI. The MDK is also operable to derive the UDK based on the difference between the new UKI and the current UKI.

At step 706, the KIC device 101 stores the new UKI in storage 400.

At step 707, the KIC device 101 transmits the new unit key and/or new UKI via messages 108 and/or 110.

### 5. COMPUTER SYSTEM FOR EXECUTING SOFTWARE

One or more of the steps and functions described herein and one or more of the components of the systems described herein may be implemented as computer code comprising computer readable instructions stored on a computer readable storage device, such as memory or another type of storage device. The computer code is executed on a computer system, such as computer system 800 described below by a processor, such as an application-specific integrated circuit (ASIC), or other type of circuit. The code may exist as software programs comprised of program instructions in source code, object code, executable code or other formats.

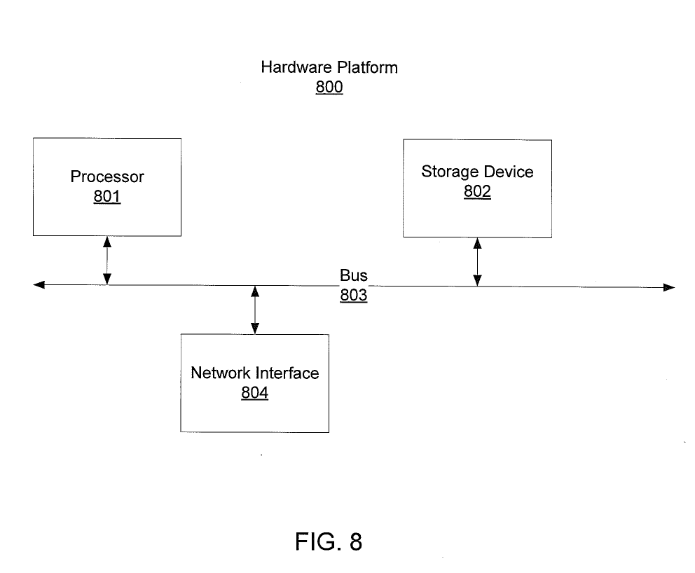

FIG. 8 shows a computer system 800 which may be used as a hardware platform for the client device 105, the HF device 104 or the KIC device 102. Computer system 800 may be used as a platform for executing one or more of the steps, methods, and functions described herein that may be embodied as software stored on one or more computer readable storage devices, which are hardware storage devices.

The computer system 800 includes a processor 801, or processing circuitry, that may implement or execute software instructions performing some or all of the methods, functions and other steps described herein. Commands and data from processor 801 are communicated over a communication bus 803. Computer system 800 also includes a computer readable storage device 802, such as random access memory (RAM), where the software and data for processor 801 may reside during runtime. Storage device 802 may also include non-volatile data storage. Computer system 800 may include a network interface 804 for connecting to a network. It is apparent to one of ordinary skill in the art that other known electronic components may be added or substituted in computer system 800.

The disclosed devices and methods enable the convenient and secure installation of an updated unit key at a client device by utilizing a UDK which is be stored in the client device. The UDK is especially advantageous for use in a cryptographic system after a security compromise occurs at a headend in the cryptographic system. The UDK stored at the client device enables the client device to derive a new unit key which corresponds with a new unit key provided at the headend by a key infrastructure center to replace the compromised unit key at the headend. By utilizing the UDK, previously stored in the client device, there is no need to compromise overall security in the cryptographic system by transmitting the UDK over a communications network. Furthermore, the unit key may be derived conveniently at the client device, without any need for transporting the client device to a customer service center or other offline location where a new unit key might otherwise be installed directly into the client device.

Furthermore, the devices and methods described herein are generally described with respect to a cryptographic system operable for content distribution purposes. However, the devices and methods are applicable to cryptographic systems for other types of conditional access data.

While the embodiments have been described with reference to examples, those skilled in the art are able to make various modifications to the described embodiments without departing from the scope of the embodiments as described in the following claims, and their equivalents.

What is claimed is:

1. A client device which utilizes a unit derivation key (UDK), a current unit key, a current unit key index (UKI) and a received UKI, the client device comprising:
a processor to
receive the received UKI,
compare the received UKI with a current UKI,
if the received UKI is not equivalent to the current UKI,
utilize the UDK, the current unit key and the received UKI to derive a new unit key.

2. The client device of claim 1, wherein the UDK is operable to derive the new unit key by applying a function to the current unit key one or more number of times associated with a numerical difference between the received UKI and the current UKI.

3. The client device of claim 2, wherein the function is one of encrypting, decrypting and hashing.

4. The client device of claim 1, wherein the processor authenticates the received UKI.

5. The client device of claim 1, wherein the processor is to
if the received UKI is not equivalent to the current UKI,
store the received UKI in a storage device in the client device, wherein the received UKI is associated with the new unit key.

6. The client device of claim 1, wherein the current unit key and the new unit key are operable in the client device to decrypt a service key controlling access to content received at the client device.

7. The client device of claim 1, wherein at least one of the UDK, an current unit key and the current UKI is received for installation in the client device from a source outside of a communications network.

8. A method of utilizing a unit derivation key (UDK), a current unit key, a current unit key index (UKI) and a received UKI, the method comprising:
receiving the received UKI, using a processor;
comparing the received UKI with a current UKI;
if the received UKI is not equivalent to the current UKI,
utilizing the UDK, the current unit key and the received UKI to derive a new unit key.

9. The method of claim 8, wherein the UDK is operable to derive the new unit key by applying a function to the current unit key one or more number of times associated with a numerical difference between the received UKI and the current UKI.

10. The method of claim 9, wherein the function is one of encrypting, decrypting and hashing.

11. The method of claim 8, the method further comprising
authenticating the received UKI.

12. The method of claim 8, wherein
if the received UKI is not equivalent to the current UKI,
the method further comprising
storing the received UKI, wherein the received UKI is associated with the new unit key.

13. The method of claim 8, wherein the current unit key and the new unit key are operable to decrypt a service key controlling access to content.

14. The method according to claim 8, wherein at least one of the UDK, an current unit key and the current UKI is received from a source outside of a communications network.

15. A non-transitory computer readable medium storing computer readable instructions that when executed by a computer system perform a method of utilizing a unit derivation key (UDK), a current unit key, a current unit key index (UKI) and a received UKI, the method comprising:
receiving the received UKI, using a processor;
comparing the received UKI with a current UKI;
if the received UKI is not equivalent to the current UKI,
utilizing the UDK, the current unit key and the received UKI to derive a new unit key.

16. A headend facility (HF) device associated with a HF, which utilizes a current unit key, a current unit key index (UKI), the HF device comprising:
a processor to
if the current unit key is compromised,
apply a function to change the current UKI stored in the HF device to derive a new UKI in which a numerical difference differentiates the new UKI and the current UKI, and
transmit the new UKI.

17. The (HF) device of claim 16, wherein the function to change is one of incrementing, decrementing or random selection.

18. The (HF) device of claim 16, wherein the processor is to
transmit the new UKI, the current UKI, the current unit key and a client device unit identification to a key infrastructure center (KIC), and
receive a new unit key from the KIC.

19. The (HF) device of claim 16, wherein the processor is to
transmit the new UKI to a client device.

20. A method of utilizing a current unit key and a current unit key index (UKI), the method comprising:
if the current unit key is compromised,
applying a function, using a processor, to change the current UKI stored in the HF device to derive a new UKI in which a numerical difference differentiates the new UKI and the current UKI, and
transmitting the new UKI.

21. The method of claim 20, wherein the function to change is one of incrementing, decrementing or random selection.

22. The method of claim 20, wherein
the transmitting includes transmitting the new UKI, the current UKI, the current unit key and a client device unit identification to a key infrastructure center (KIC), the method further comprising
receiving a new unit key from the KIC.

23. The method of claim 20, wherein
the transmitting includes transmitting the new UKI to a client device.

24. A non-transitory computer readable medium storing computer readable instructions that when executed by a computer system perform a method of utilizing a current unit key and a current unit key index (UKI), the method comprising:
if the current unit key is compromised,
applying a function, using a processor, to change the current UKI stored in the HF device to derive a new UKI in which a numerical difference differentiates the new UKI and the current UKI, and
transmitting the new UKI.

25. A key infrastructure center (KIC) device associated with a KIC, which is operable to utilize a derivation key, a received unit key index (UKI), a current UKI, a client device unit identification and a current unit key, the KIC device comprising:
a processor to
receive the received unit key index (UKI), the client device unit identification and the current unit key,
compare the received UKI with a current UKI,
if the received UKI is not equivalent to the current UKI,
utilize the derivation key, the client device unit identification, the current unit key, the current UKI and the received UKI to derive a new unit key.

26. The KIC device of claim 25, wherein the derivation key is operable to derive the new unit key by applying a function to the current unit key one or more number of times associated with a numerical difference between the received UKI and the current UKI.

27. The KIC device of claim 26, wherein the function is one of encrypting, decrypting and hashing.

28. The KIC device of claim 26, wherein the derivation key is a unit derivation key (UDK).

29. The KIC device of claim 26, wherein the derivation key is a master derivation key (MDK) and the MDK is operable to derive a UDK based on the difference between the new UKI and the current UKI, and the UDK is operable to derive the new unit key by applying a function to the current unit key one or more number of times associated with the difference between the new UKI and the current UKI.

30. A method of utilizing a derivation key, the method comprising:
receiving a received unit key index (UKI), a client device unit identification and a current unit key;
comparing the received UKI with a current UKI, using a processor;
if the received UKI is not equivalent to the current UKI,
utilizing a client device unit identification, the current unit key, the current UKI and the received UKI and the derivation key to derive a new unit key.

31. The method of claim 30, wherein the derivation key is operable to derive the new unit key by applying a function to the current unit key one or more number of times associated with a numerical difference between the received UKI and the current UKI.

32. The method of claim 31, wherein the function is one of encrypting, decrypting and hashing.

33. The method of claim 30, wherein the derivation key is a unit derivation key (UDK).

34. The method of claim 30, wherein the derivation key is a master derivation key (MDK) and the MDK is operable to derive a UDK based on the difference between the new UKI and the current UKI, and the UDK is operable to derive the new unit key by applying a function to the current unit key one or more number of times associated with the difference between the new UKI and the current UKI.

35. A non-transitory computer readable medium storing computer readable instructions that when executed by a computer system perform a method of utilizing a derivation key, the method comprising:
receiving a received unit key index (UKI), a client device unit identification and a current unit key;
comparing the received UKI with a current UKI, using a processor;
if the received UKI is not equivalent to the current UKI,
utilizing a client device unit identification, the current unit key, the current UKI and the received UKI and the derivation key to derive a new unit key.
